(19) United States
(12) Patent Application Publication
(10) Pub. No.: US 2019/0386386 A1
(43) Pub. Date: Dec. 19, 2019

(54) Antenna

(71) Applicant: Nokia Solutions and Networks OY, Espoo (FI)

(72) Inventors: Alfonso Fernandez, Madrid (ES); Gloria Touchard, Madrid (ES); Luis Inclan Sanchez, Madrid (ES); Eva Rajo Iglesias, Madrid (ES)

(73) Assignee: Nokia Solutions and Networks OY, Espoo (FI)

(21) Appl. No.: 16/441,944

(22) Filed: Jun. 14, 2019

(30) Foreign Application Priority Data
Jun. 19, 2018 (EP) 18178502.3

(51) Int. Cl. H01Q 1/36; H01Q 1/12

(52) U.S. Cl. CPC H01Q 1/36; H01Q 1/12

(57) ABSTRACT

An antenna includes a first element having a first conductive grid structure, a second element having a second conductive grid structure, and one or more spacers made of an electrically isolating material extending out of the first element to the second element, wherein the first conductive grid structure is spaced apart from the second conductive grid structure by the one or more spacers and air, wherein the one or more spacers support the first conductive grid structure, and wherein the first conductive grid structure defines a unitary body. A method of manufacturing such antenna includes 3D printing one or more spacers of an electrically isolating material to extend from the first element to the second element.

### TECHNICAL FIELD

The disclosure relates to an antenna, in particular an antenna for a high capacity wireless access system.

### BACKGROUND

High capacity Fixed Wireless Access systems need to use high efficiency and directivity antennas. In many cases this is leading to the construction of very bulky antennas especially but not exclusively in frequencies below 5 GHz. A typical antenna will consist on a phased array antenna with multiple radiating elements and a ground plane with a dielectric material between the patches and the ground plane.

In the context of capacity increase due to spatial diversity, the more capacity and bandwidth efficiency are required the larger the number of radiating elements and hence the larger the ground plane area.

Taking 3.5 GHz band as an example, building a 256-element phased array, typically requires in the order of 5000 cm² of area.

For additional double polarization an antenna size of up to 1 m² may be required. The size can become even larger if the frequencies are lower like the common 2.6 GHz, 2.1 GHz, 1.8 GHz. The antenna size may be increasingly growing for emerging standards both on base station/Access Point and on the Customer Premises Equipment side.

### SUMMARY

In view of this, some embodiments aim at providing an improved transmissibility regarding wind and visible radiation.

According to one aspect, an antenna, has a first element having a first conductive grid structure, a second element having a second conductive grid structure, and one or more spacers made of an electrically isolating material extending out of the first element to the second element, wherein the first conductive grid structure is spaced apart from the second conductive grid structure by said one or more spacers and air, wherein the one or more spacers support the first conductive grid structure, and wherein the first conductive grid structure defines a unitary body. Being self-supporting, the first conductive grid structure has no substrate or the like between the holes of the conductive grid. Therefore light and wind can penetrate easily through the antenna. The lack of substrate immediately reduces to a minimum the losses associated with the dielectric and evidently reduces the cost of any radiant element designed by this technique.

According to a further aspect, the second conductive grid structure is a unitary body. Being a unitary body, the second conductive grid structure has no substrate or the like between the holes of the conductive grid. This provides an antenna that is further improved with regard to transmissibility.

According to an aspect of the disclosure, the spacer comprises a dielectric support. This isolates the first and second conductive grid structures required for resonance.

According to a further aspect, comprising a third conductive grid structure electrically connected to the second element. This third conductive grid structure is a semi-transparent extension of the second conductive grid structure.

According to a further aspect, the third element and the second element are disposed in a plane parallel to the first element. The antenna is fed this way from one side of the patch. This is a very compact structure for the antenna.

According to a further aspect, the third conductive grid structure forms part of a transmission line for feeding the resonant structure. This provides a transmission line with semi-transparency near the antenna.

A patch antenna operating in its fundamental mode has approximate dimensions of half a wavelength in the dielectric substrate. In the present case, the substrate is air, so the dimensions are approximately half the wavelength. For its operation, the grid antenna must have a grid step size smaller than half the wavelength.

According to a further aspect a grid step pattern size of at least one of the grids is smaller than a wave length corresponding to a frequency of radiation of the resonant structure, and wherein the size is a multiple of ⅛ times the wave length of said frequency of radiation. The antenna is built based on a grid pattern with steps much smaller than the wave length, for instance in a range between ⅛ times the wave length and 1/36 times the wave length. For a wave length λ a patch may have a λ/2 dimension. Grid step sizes between half λ/4 and four times lower λ/36 are preferably contemplated.

According to a further aspect, the first conductive grid structure and the second conductive grid structure are of square shape and have a same grid size, wherein the grid patterns are aligned axially. This is an antenna with grids with the same density and pattern that are aligned to minimize the visual impact.

According to a further aspect, the first element, the second element and the third element are connected to a signal source by at least one transmission line or at least one feed line formed as a grid, said at least one transmission line or said at least one feed line being in a respective plane of said first element, second element and third element. This structure connects to the signal source in a more transparent way.

The distance between the grids depends on the resonant frequency and other antenna characteristics like impedance and bandwidth. The distance between the metallic grid layers determines the bandwidth of the antenna. In most cases it is between 1/50 and 1/10 times the wave length. The non-conductive support impacts the resonant frequency as well. Spreading the supports spaced apart and throughout the grid minimizes the impact of the non-conductive support on the resonant frequency.

The grid lines of the conductive layers and the dielectric supports are coincident in the same vertical axis to maximize the transmission of light and wind. Although alignment is the preferred option, it may be required that some elements in the design of the antenna, either from the metallic grid layer of the antenna or from the supporting dielectric elements or from both at the same time, do not coincide with this axis. This could be a case of a part of a grid line that goes into the structure of the radiating element where the space in both sides may not match a multiple of the grid step.

According to a further aspect, the antenna comprises a feed point disposed on a side of the antenna. This allows arranging several antennas next to each other.

According to a further aspect, the feed point is disposed in plane with the second conductive grid structure. This provides a compact antenna.

Regarding manufacturing a resonant structure the method comprises manufacturing a first element having a first conductive grid structure and a second element having a second conductive grid structure, and 3D printing one or more spacers of an electrically isolating material to extend from the first element to the second element, wherein the first conductive grid structure is spaced apart from the second conductive grid structure by said one or more spacers and air, wherein the spacer supports the first conductive grid structure.

Preferably the antenna is 3D printed using dielectric material, and in a subsequent step, a conductive coating is applied to each one of the grids, keeping the one or more spacers uncoated. This way only the conductive grid structures are coated and the supports are non-conductive.

### BRIEF DESCRIPTION OF THE FIGURES

Further features, aspects and advantages of the embodiments are given in the following detailed description with reference to the drawings in which:

FIG. 1 schematically depicts a ground plane conductive grid of an antenna,

FIG. 2 schematically depicts a conductive patch grid of the antenna,

FIG. 3 schematically depicts a radiating element feeding grid of the antenna,

FIG. 4 schematically depicts a top view of the antenna,

FIG. 5 schematically depicts a first side view of the antenna,

FIG. 6 schematically depicts a second side view of the antenna,

FIG. 7 schematically depicts a frequency response for the antenna.

### DESCRIPTION OF ILLUSTRATIVE EMBODIMENTS

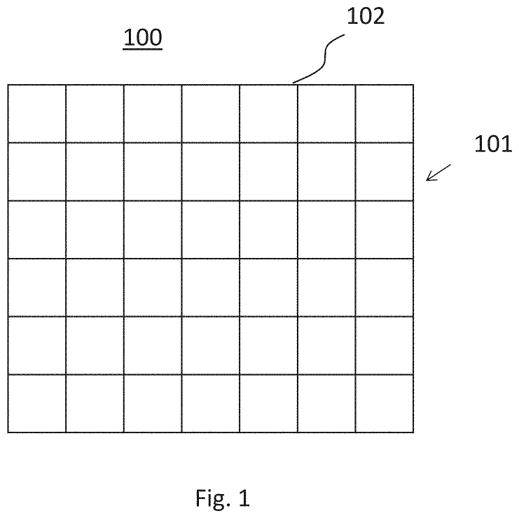

FIG. 1 schematically depicts a first element 101 having a first conductive grid structure 102. The first element 101 forms a ground plane conductive grid of an antenna 100.

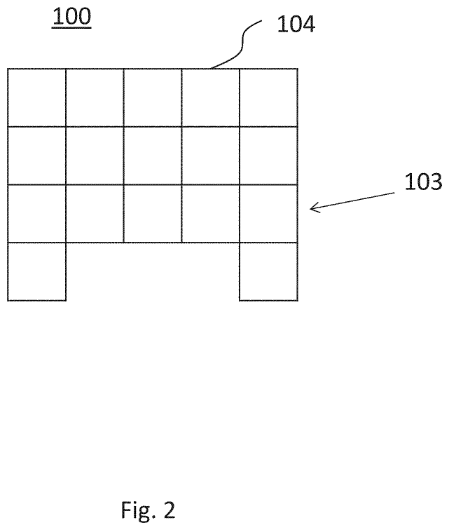

FIG. 2 schematically depicts a second element 103 having a second conductive grid structure 104. The second element 103 forms a conductive patch grid of the antenna 100.

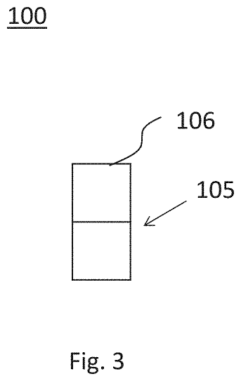

FIG. 3 schematically depicts a third element 105 having a third conductive grid structure 106. The third element forms a radiating element feeding grid of the antenna 100.

Herein, the term “radiating element” is to be construed as to mean that the element is configured for, or capable of radiating so as to encompass, without limitation, situations in which the element is not in operation.

The conductive grid structures are formed as radiating elements which are non-solid patches, built as a grid conductive surface.

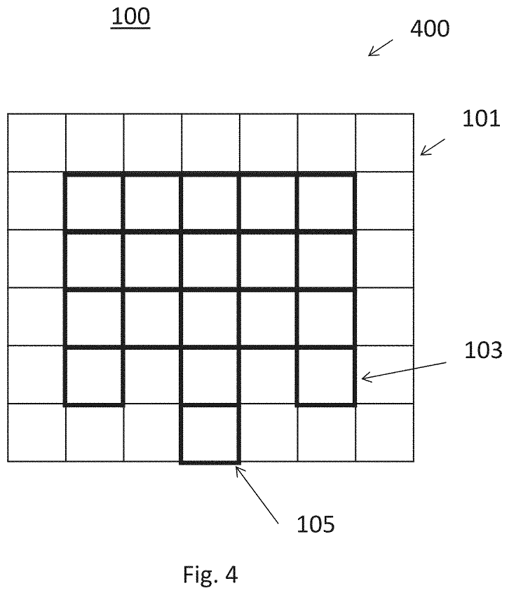

FIG. 4 schematically depicts a top view of parts of the antenna 100 having a resonant structure 400 comprising the first element 101, the second element 103 and the third element 105.

Herein, the term “resonant structure” is to be construed as to mean that the structure is configured for, or capable of resonating so as to encompass, without limitation, situations in which the structure is not in operation.

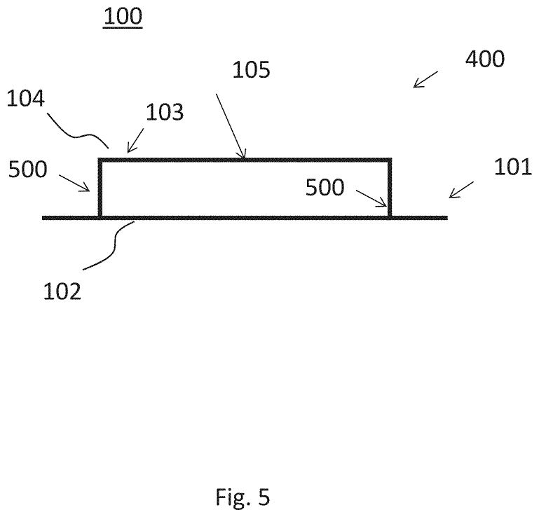

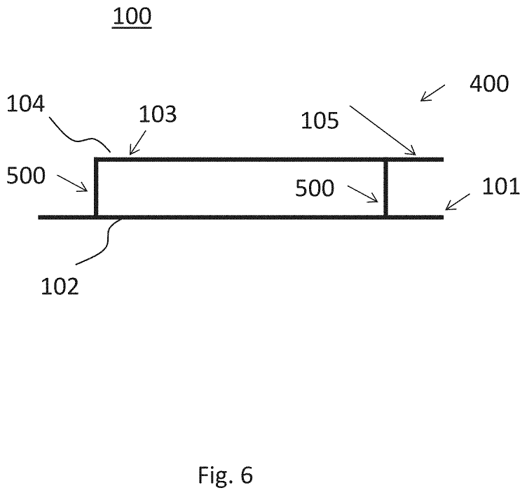

FIG. 5 schematically depicts a first side view of the antenna 100. FIG. 6 schematically depicts a second side view of the antenna 100.

Additionally to the elements described above, both side views depict a spacer structure 500 made of an electrically isolating material 500 extending out of a plane defined by the first element 101 to the second element 103. Such extension of the spacer 500 out of the plane of the first element 101 may be in a perpendicular or non-perpendicular arrangement with respect to the plane of the first element 101.

The first conductive grid structure 102 is spaced apart from the second conductive grid structure 104 by means of the spacer 500.

The spacer 500 supports the first conductive grid structure 102. The first conductive grid structure 102 extends radially, that is in a same plane defined by the structure itself, and defines a unitary body. Preferably the unitary body is self-supporting. Self-supporting in this context means the first conductive grid structure 102 requires neither substrate nor other carrier. This improves transmissibility regarding wind and light.

For example a metallic mesh is used to realize the conductive parts of the antenna 100. In other words, using self-supporting conductors an optically semi-transparent antenna is built to pass light and wind through the antenna. The metal elements allow the antenna to work properly as a radiator. The simplest design for this type of antenna is a rectangular or square patch. As spacer 500 a transparent dielectric can be used. For example polycarbonate material is used as dielectric.

The second conductive grid structure 104 may be self-supporting as well. This improves transmissibility regarding wind and light further.

More specifically the antenna 100 forms a Patch Grid semi-transparent antenna without needing a substrate. More specifically the antenna 100 is an antenna designed for cellular communications that can be located at part of an infrastructure or as customer premises equipment. The antenna 100 has for example a patch size of 4.62 cm×4.62 cm for both transmission and reception of radio frequencies having 2.6 GHz. The antenna 100 may have a patch size of 1.5×1.5 cm for both transmission and reception of radio frequencies of 6 GHz. The size of the antenna 100 may depend on the dielectric used between the first conductive grid structure 102 and the second conductive grid structure 104. If such dielectric is air, at frequencies of 900 MHz, the λ/2 resonant size is approximately 16.6 cm. The antenna is not necessarily square and may have any suitable shape. For example, the non-resonant side of a square antenna may be adapted to improve impedance matching. The antenna 100 may be conceived from frequencies between the aforementioned frequencies using corresponding patch sizes. The antenna 100 is able to transmit and receive radio signals simultaneously. In a further aspect, the antenna 100 is compatible with the emerging structures used in 5G cellular communications using massive MIMO with a large number of individually controlled patches or groups of patches.

In an aspect, the antenna 100 is intended for replicating a patch structure formed by an array of resonant structures 400 comprising as many such structures as is required for making a ground plane of the antenna 100 larger. In case of massive MIMO using 3.5 GHz and 256 MIMO antennas with H and V polarization the ground plane for example fills a 1 m² surface.

In an aspect, a distance between the first conductive grid structure 102 and the second conductive grid structure 104 may depend on the wave length λ and ranges for example between λ/10 and λ/50. Even in the case of a large antenna structure with many patches, the thickness from ground plane to patches may still be kept in the order of 1 cm, resulting in a very thin antenna 100.

The first conductive grid structure 102 is supported by non-conductive mechanical support struts forming the spacer 500. In an aspect, the struts are disposed radially spaced apart from each other and extending vertically out of a plane defined by the first element 101 to the second element 103. In another aspect, the support elements may be configured to deviate from the vertical extension, i.e. to extend at an angle relative to the vertical plane. The cross-section of the grid cords has to meet a trade-off of performance. The larger the cross-section is the better the antenna performance and the higher the opacity of the antenna.

In an aspect, the spacer 500 comprises a dielectric support. In an aspect, the non-conductive mechanical supports form the dielectric spacer.

In the example, the spacer 500 consists of four struts, each attached at respective corners of the second element 102 having the same thickness as the self-supporting grid structure. Other distributions and thickness may be used.

In an aspect, the first element 101, the second element 103 and the third element 105 are connected to a signal source by at least one transmission line or at least one feed line formed as a grid.

In an aspect, the third conductive grid structure 106 is electrically connected to second conductive grid structure 103. The third element 105 is electrically connected to the second element 103. In a further aspect, the third conductive grid structure 106 is self-supporting. For example the third conductive grid structure 106 is a metallic mesh.

In an aspect, the third element 105 and the second element 103 are disposed in a plane parallel to the first element 101.

In an aspect, the third conductive grid structure 106 forms part of the transmission line for feeding the resonant structure 400.

In an aspect, the antenna 100 comprises a feed point disposed on a side of the antenna 100.

In a further aspect, the feed point is disposed in plane with the second conductive grid structure 104.

In an aspect, a grid step pattern size of at least one of the grids is smaller than a wave length corresponding to a radiating frequency of the resonant structure 400. The weight of the antenna 100 is reduced significantly while maintaining the desired radiating frequency.

In an aspect, the grid step pattern size is a multiple of ¼ times a wave length of the radiating frequency. The antenna may be built based on a grid pattern with steps much smaller than the wave length, for instance in a range between ⅛ times the wave length and 1/36 times the wave length. This allows reducing the weight of the antenna 100.

In an aspect, the first conductive grid structure 102 and the second conductive grid structure 104 are of square shape and have a same grid step pattern size.

In a further aspect the grid pattern of the grids are aligned axially to each other. Aligned in this context refers to a shape and a size of the grids where one grid at least partially conceals the other in a top view of the antenna 100. In a further aspect, the grids are of different circumferential dimensions.

In an aspect, the antenna 100 is of planar type. This means that each of the grids of the antenna 100 is flat. In another aspect, at last a part of at least one otherwise planar grid of the antenna 100 has a curvature. The curvature may be designed due to any practical requirements. For example a mechanical match to a curved surface in the surroundings of the antenna 100 may require a curvature. In these cases, to maintain the radiating features of the antenna 100, the design of the grids and or the spacers 500 may be adapted in dimensions. More specifically, the ground plane, the patches and feed lines may have respective curvatures and may be adapted to meet the same requirements as the planar design with respect to radiating. The spacing between the ground plane and the radiating elements and the feed lines will be kept constant in this case. For example the shape of the antenna is adapted to match the curvature of a helmet. For example an antenna having a curvature is matched to a size of the patch in that an average radius of the curvature has twice the size of the patch or is approximately equal to the wave length. The shape of the antenna that is matched may not be necessarily a pure sphere. Antennas having spheroids, ellipsoids paraboloids or the like may be matched as well using the average radius.

As further clarification, it is to be noted that in the case of non-planar antennas (i.e. antennas having curvature as stated above), any reference herein to a plane defined by any one of the first or the second elements (101, 103) is to be construed as a plane perpendicular to the radius of the curvature at the point where a structure, e.g. a spacer, extends out of the first or the second element.

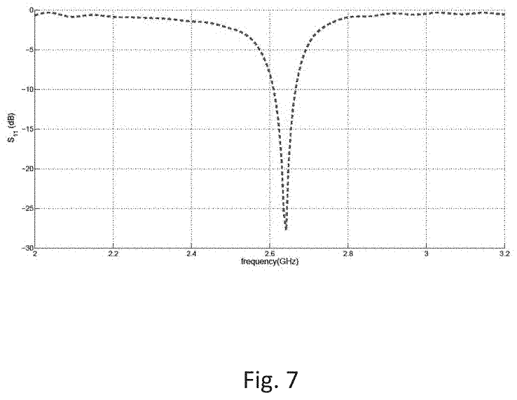

FIG. 7 schematically depicts a frequency response for the antenna 100. The x-axis depicts the frequency in GHz, the y-axis the S₁₁ in dB.

A method of manufacturing an antenna 100 comprising a resonant structure 400, comprises disposing a first element 101 having a first conductive grid structure 102 and a second element 103 having a second conductive grid structure 104, and 3D printing an spacer 500 to extend out of a plane of the first element 101 to the second element 103, wherein the first conductive grid structure 102 is spaced apart from the second conductive grid structure, wherein the spacer 500 supports the first conductive grid structure 102, and wherein the first conductive grid structure 102 extends radially self-supporting from the spacer 500.

The antenna 100 may be 3D printed using dielectric material. In this case in a subsequent step, a conductive coating is applied to each one of the grids, keeping the one or more spacers uncoated.

The description and drawings merely illustrate the principles of exemplary embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of exemplary embodiments and the concepts contributed by the inventor(s) to furthering the art, and are to be construed as being without limitation to such specifically recited examples and conditions. Moreover, all statements herein reciting principles, aspects, and embodiments, as well as specific examples thereof, are intended to encompass equivalents thereof.

1. An antenna, comprising:
a first element having a first conductive grid structure,
a second element having a second conductive grid structure, and
one or more spacers made of an electrically isolating material extending out of the first element to the second element,
wherein the first conductive grid structure is spaced apart from the second conductive grid structure by said one or more spacers and air,
wherein the one or more spacers support the first conductive grid structure, and wherein the first conductive grid structure defines a unitary body.

2. The antenna of claim 1, wherein the second conductive grid structure is a unitary body.

3. The antenna of claim 1, wherein the spacer comprises a dielectric support.

4. The antenna according to claim 1, comprising a third conductive grid structure electrically connected to the second element.

5. The antenna according to claim 4, wherein the third element and the second element are disposed in a plane parallel to the first element.

6. The antenna according to claim 4, wherein the third conductive grid structure forms part of a transmission line for feeding a resonant structure.

7. The antenna according to claim 1, wherein a grid step pattern size of at least one grid of the first and second grid structures is smaller than a wave length corresponding to a frequency of radiation of a resonant structure, and wherein the size is a multiple of ⅛ times the wave length of said frequency of radiation.

8. The antenna according to claim 7, wherein the first conductive grid structure and the second conductive grid structure are of square shape and have a same grid size, wherein the grid patterns are aligned axially.

9. The antenna according to claim 7, wherein the first element, the second element and the third element are connected to a signal source by at least one transmission line or at least one feed line formed as a grid, said at least one transmission line or said at least one feed line being in a respective plane of said first element, second element and third element.

10. The antenna according to claim 1, wherein the antenna comprises a feed point disposed on a side of the antenna.

11. The antenna according to claim 10, wherein the feed point is disposed in plane with the second conductive grid structure.

12. A method of manufacturing an antenna comprising:
manufacturing a first element having a first conductive grid structure and a second element having a second conductive grid structure, and
3D printing one or more spacers of an electrically isolating material to extend from the first element to the second element,
wherein the first conductive grid structure is spaced apart from the second conductive grid structure by said one or more spacers and air,
wherein the spacer supports the first conductive grid structure.

13. The method of claim 12, wherein the 3D printing prints using a dielectric material, and subsequently, the method further includes applying a conductive coating to each one of the grids, keeping the one or more spacers uncoated.
